(19) United States
(12) Patent Application Publication
(10) Pub. No.: US 2012/0300366 A1
(43) Pub. Date: Nov. 29, 2012

(54) METHOD FOR PRE-DOPING ANODE AND LITHIUM ION CAPACITOR STORAGE DEVICE INCLUDING THE SAME

(75) Inventors: Ji Sung Cho, Gyeonggi-do (KR); Sang Kyun Lee, Gyeonggi-do (KR); Hyun Chul Jung, Gyeonggi-do (KR); Bae Kyun Kim, Gyeonggi-do (KR)

(73) Assignee: Samsung Electro-Mechanics Co., Ltd., Suwon (KR)

(21) Appl. No.: 13/463,321

(22) Filed: May 3, 2012

(30) Foreign Application Priority Data
May 27, 2011 (JP) 10-2011-0050700

(51) Int. Cl. H01G 9/155; C25D 7/00; H01G 9/15; H01G 9/04; H01G 4/30; H01G 9/145

(52) U.S. Cl. 361/502; 29/25.41; 361/508; 361/528; 205/59

(57) ABSTRACT

Disclosed herein are a method for pre-doping an anode and a lithium ion capacitor storage device including the same. The method of the present invention includes: disposing lithium metal films and anodes alternately; and charging the lithium metal films and the anodes to directly pre-dope lithium metal contained in the lithium metal films onto the anodes. The lithium ion capacitor storage device is manufactured by the method. According to the present invention, the lithium ion capacitor storage device including the anode can provide a high-capacitance capacitor capable of operating even at a high voltage range of up to 3.8V to 2.0V, and ensure high reliability even in a high-temperature (60° C.) cycle.

### CROSS REFERENCE(S) TO RELATED APPLICATIONS

This application claims the benefit under 35 U.S.C. Section 119 of Korean Patent Application Serial No. 10-2011-0050700, entitled “Method for Pre-doping Anode and Lithium Ion Capacitor Storage Device including the Same” filed on May 27, 2011, which is hereby incorporated by reference in its entirety into this application.

### BACKGROUND OF THE INVENTION

1. Technical Field

The present invention relates to a method for pre-doping an anode and a lithium ion capacitor storage device including the same.

2. Description of the Related Art

An electric double layer capacitor (EDLC) has more excellent input and output characteristics and higher cycle reliability than a secondary battery such as a lithium ion secondary battery. In recent, the electric double layer capacitor is being successfully developed in connection with environmental problems, and has bright aspects in, for example, a main power and an auxiliary power of an electric vehicle, or an electric power storage device of reproducible energy such as solar power generation or wind power generation. In addition, the electric double layer capacitor is expected to be also utilized as a device capable of outputting large current for a short time in an uninterruptible power supply, which has been increasingly demanded by information technology (IT).

This electric double layer capacitor has a principle in which a pair or plural pairs of polarizable electrodes (anode and cathode) face each other with a separator therebetween in an electrolytic solution, and charges are stored in electric double layer formed at interfaces between the polarizable electrodes and the electrolytic solution.

On the other hand, a capacitor using an electrolytic solution containing lithium ions, that is, an asymmetric type lithium ion capacitor storage device is suggested for the purpose of further increasing energy density.

In this lithium ion capacitor storage device containing lithium ions, since a cathode and an anode are different from each other in materials or functions, an activated carbon is used as a cathode active material, and a carbon material capable of easily adsorbing or desorbing the lithium ions in a reversible way is used as an anode active material. A separator is inserted between the cathode and anode, and the resultant structure is immersed in the electrolytic solution containing a lithium salt. The lithium ion capacitor storage device is used while the lithium ions are previously adsorbed on the anode.

With respect to capacitance of the lithium ion capacitor storage device containing lithium ions, negative ions in the electrolytic solution are adsorbed on the cathode and the lithium ions in the electrolytic solution are adsorbed on the anode, at the time of charging. Meanwhile, the negative ions adsorbed on the cathode are desorbed and the lithium ions adsorbed on the anode are desorbed, at the time of discharging.

In the above lithium ion capacitor storage device containing lithium ions, the electric potential of the anode is kept lower than the electric potential of the electrolytic solution because the lithium ions are previously adsorbed on the anode. For this reason, the lithium ion capacitor storage device containing lithium ions has improvement in withstand voltage and improvement in capacitance thereof itself as compared with the general electric double layer capacitor, thereby obtaining large energy density. In addition, the lithium ion capacitor storage device containing lithium ions can be discharged until the electric potential of the anode is equal to or lower than the electric potential of the electrolytic solution, thereby widening a range of the using voltage, resulting in higher energy density.

However, as for a product where a lithium metal is attached on a surface of an electrode or a lithium metal is added into an anode, if the lithium remains, there are problems in safety of a lithium ion capacitor storage device. Furthermore, when pre-doping of the lithium metal is performed in a physical contact manner or a short manner, reproducibility is deteriorated.

As such, since the pre-doping performed in the contact manner or short manner lacks reproducibility, a process to solve this problem is needed.

### SUMMARY OF THE INVENTION

An object of the present invention is to provide a method for pre-doping an anode, capable of improving reproducibility in manufacturing of a lithium ion capacitor.

Another object of the present invention is to provide a lithium ion capacitor including the anode obtained by pre-doping.

According to an exemplary embodiment of the present invention, there is provided a method for pre-doping an anode, including: disposing lithium metal films and anodes alternately; and charging the lithium metal films and the anodes to directly pre-dope lithium metal contained in the lithium metal films onto the anodes.

A separator may be disposed between the lithium metal film and the anode.

The lithium metal film may be fixed to a current collector of at least one selected from a group consisting of nickel, copper, aluminum, and an alloy thereof.

A separate electrolytic solution may be unnecessary at the time of pre-doping.

A content of lithium pre-doped may be 80 to 95% of anode capacity.

The charging may be performed under the condition of 0.005 to 2 A for 10 to 24 hours.

Discharging after charging may be not performed at the time of pre-doping.

According to an exemplary embodiment of the present invention, there is provided a lithium ion capacitor including the anode manufactured by the pre-doping method.

An active material for the anode may bee selected from carbon materials having an interplanar spacing of [002] surface of 0.335 to 0.410 nm, which is measured by an X-ray diffraction method.

According to an exemplary embodiment of the present invention, there is provided a method for manufacturing a lithium ion capacitor, including: stacking cathodes and anodes, which are insulated from each other by separators; and charging the stacked anodes by using lithium metal films to pre-dope lithium ions of the lithium metal films onto the anodes.

The lithium metal films may have a stacked structure in order to charge the respective anodes stacked.

The lithium ion metal film may contain lithium ions, of which a content is such that the lithium ions are pre-doped onto the anode.

A content of lithium ions pre-doped onto the anode may be 0 to 95% of anode capacity.

The lithium metal film may be fixed to a current collector of at least one selected from a group consisting of nickel, copper, aluminum, and an alloy thereof.

The charging may be performed under the condition of 0.005 to 2 A for 10 to 24 hours.

An active material for the anode may be selected from carbon materials having an interplanar spacing of [002] surface of 0.335 to 0.410 nm, which is measured by an X-ray diffraction method.

### DESCRIPTION OF THE PREFERRED EMBODIMENTS

Hereinafter, the present invention will be described in more detail as follows, but the present invention is not limited thereto.

The present invention is directed to a method for pre-doping an anode with lithium ions and a lithium ion capacitor storage device including the same.

Two methods for pre-doping an anode with lithium ions are largely used.

As for a first method, unit anodes are pre-doped with lithium ions, and then dried. The pre-doped anodes thus obtained and cathodes are stacked while they are insulated from each other by separators.

Specifically, lithium metal films and anodes are alternately disposed; and the lithium metal films and the anodes are charged to directly pre-dope lithium metal contained in the lithium metal films onto the anodes.

In this case, the pre-doping is performed while the lithium metal films and the anodes are insulated from each other by the separators.

A film consisting of only the lithium metal may be used alone as the lithium metal film. The lithium metal film may be fixed to a current collector formed of at least one selected from a group consisting of nickel, copper, aluminum, and a mixture thereof.

The pre-doping method according to the present invention is characterized in that the lithium ions of the lithium metal film are directly pre-doped on the anode without containing a separate electrolytic solution. In other words, when the lithium ions contained in the electrolytic solution are pre-doped on the anode, there is a limitation in the concentration of the lithium ions contained in the electrolytic solution. Therefore, a separate member capable of continuously supplying the lithium ions is needed, which causes a process to be complicated and inconvenient. Furthermore, the pre-doping needs to be preformed for three or four days, or as long as one week, and thus it requires great time and it is disadvantageous economically.

However, when the pre-doping method according to the present invention is performed, the lithium ions contained in the lithium metal film are directly pre-doped on the anode without containing a separate electrolytic solution.

The pre-doping may be performed while several sheets of lithium metal films and anodes are simultaneously alternated.

There is a method of charging between the lithium metal film and the anode in order that the lithium ions are pre-doped on the anode from the lithium metal film. The charging may be performed under the charging condition of 0.005 to 2 A for 10 to 24 hours. As a result, the anode can be pre-doped for a relatively short time by a simple method.

In addition, according to the present invention, an additive discharging process is not needed after charging between the lithium metal film and the anode, at the time of pre-doping. The reason is that the anode can be effectively pre-doped with lithium ions even with only the charging process.

According to the present invention, the content of lithium ions pre-doped on the anode may be regulated to a level of 80 to 95% of total anode capacity.

The present invention also provides a lithium ion capacitor including the pre-doped anode. That is, the lithium ions are previously adsorbed and stored on the anodes by charging between the lithium metal films and the anodes with the separators therebetween, and then the anodes pre-doped with the lithium ions are dried. The anodes thus obtained and cathodes are stacked while the anodes and the cathodes are insulated from each other by separators, thereby manufacturing a lithium ion capacitor.

The anode pre-doped with the lithium ions may be dried at a temperature of 50° C. to 90° C.

According to another method for pre-doping, cathodes and anodes are stacked while they are insulated from each other by separators, instead of previously pre-doping unit anodes. Then, the lithium metal films are applied to the respective stacked anodes to charge the lithium metal films and the anodes. Therefore, the lithium ions of the lithium metal film are pre-doped on the anode.

As such, according to the above method, the pre-doping is performed by manufacturing a stacked type lithium ion capacitor, determining the content of lithium ions required for the pre-doping, and charging a necessary content of the lithium ions on the anode.

The lithium metal films may have a stacked structure in order to charge the respective anodes stacked. Therefore, the lithium metal layers having a stacked structure may be positioned correspondingly to the respective anode layers.

The lithium metal film may contain lithium ions, of which a content is such that the lithium ions are pre-doped onto the anode. The content of lithium ions pre-doped on the anode may be regulated to a level of 80 to 95% of anode capacity.

A film consisting of only the lithium metal may be alone used as the lithium metal film. The lithium meal film may be fixed to a current collector formed of at least one selected from a group consisting of nickel, copper, aluminum, and a mixture thereof.

In addition, the charging may be performed under the condition of 0.225 to 2 A for 10 to 24 hours.

When pre-doping is completed, the lithium metal film is removed from the stacked type lithium ion capacitor.

In the lithium ion capacitor storage device of the present invention, an anode active material may be at least one selected from carbon materials, which are capable of reversibly adsorbing and desorbing the lithium ions and has an interplanar spacing of [002] surface of 0.335 to 0.410 nm, preferably 0.335 to 0.338 nm, which is measured by an X-ray diffraction method.

If the interplanar spacing of [002] surface of the carbon material is greater than 0.410 nm, such carbon material is unfavorable since it has a lowered efficiency in charging and discharging cycles, which causes remarkable deterioration.

Specific examples of the carbon material satisfying this condition may include natural graphite, artificial graphite, petroleum coke, may be coconut palm, phenol resin, petroleum coke, mesopeze pitch-based carbon material, vapor grown carbon fiber thermally treated at 800 to 3000° C., non-graphite carbon material, and the like.

In addition, a material used in conventional electric double-layer capacitors or lithium ion batteries may be used for an anode current collector. Examples of the material may be stainless, copper, nickel, or an alloy thereof, and copper is preferable among them. In addition, the thickness thereof may be about 10 to 300 μm. An example of the current collector may include a metal foil, an etched metal foil, or those having holes penetrating through front and rear surfaces thereof, such as an expanded metal, a punching metal, a net, foam, or the like.

In addition, the cathode active material of the present invention may be activated carbon, which has a specific surface area of 800 to 3000 m²/g. A raw material of the activated carbon may be coconut palm, phenol resin, petroleum coke, or the like, and the activated carbon may be activated by activation with steam, activation with melt KOH, or the like.

Furthermore, the cathode may contain conductive carbon black or graphite, in order to lower conductivity thereof. The cathode and the anode may be manufactured by the same manufacturing method. The activated carbon may be molded in a sheet shape by using a binder, or a molded sheet extruded in an extrusion type may be attached to a current collector by using a conductive adhesive. In the present invention, the two electrode materials above are all preferable.

In addition, a material used in conventional electric double-layer capacitors or lithium ion batteries may be used for a cathode current collector. Examples of the material may be at least one selected from a group consisting of aluminum, stainless, titanium, tantalum, and niobium, and aluminum is preferable among them. In addition, the thickness of the current collector may be about 10 to 300 μm. An example of the current collector may include a metal foil, an etched metal foil, or those having holes penetrating through front and rear surfaces thereof, such as an expanded metal, a punching metal, a net, foam, or the like.

The cathode and the anode may be molded by using a binder as a shaping agent together with thee active material. Examples of the usable binder may include a fluorine-based resin such as polytetrafluoroethylene (PTFE), polyvinylidene fluoride (PVdF), or the like; a thermoplastic resin such as polyimide, polyamideimide, polyethylene (PE), polypropylene (PP), or the like; a cellulose-base resin such as carboxymethylcellulose (CMC) or the like; or a rubber resin such as styrene-butadiene rubber (SBR) or the like. Among them, the fluorine-based resin is preferable in view of heat resistant property and chemical stability.

An organic electrolytic solution containing lithium salt including LiBF₆, LiBF₄, LiCLO₄, LiN(CF₃SO₂)₂, CF₃SO₃Li, LiC(SOvCF₃)₃, LiAsF₆, LiSbF₆, or the like may be preferable as the electrolytic solution of the present invention. The solvent may be at least one selected from a group consisting of ethylene carbonate, propylene carbonate, dimethyl carbonate, ethylmethyl carbonate, sulfolane and dimethoxyethane, but is not limited thereto. An electrolytic solution containing solute and solvent obtained by combination of the above materials having high withstand voltage property and high electric conductivity. The electrolytic solution preferably has an electrolyte content of 0.1 to 2.5 mol/L, 0.5 to 2 mol/L.

The present invention will be described in detail by the following examples, but the present invention is not limited thereto.

### EXAMPLES

According to Example, a cell was manufactured and measured by using a cathode, an anode, and a separator, in an argon glove box at a temperature of −60° C. or less, which is a dew point.

### 1) Manufacturing of Anode

An anode was manufactured using commercially available graphite (having an interplanar spacing of [002] surface of 0.338 nm, which is measured by an X-ray diffraction method). Graphite, acetylene black, and binders (CMS/SBR) were mixed at a weight ratio of 80:10:10, respectively. Then, the mixture was added to water, followed by agitation and mixing, thereby obtaining slurry. This slurry was coated on a copper foil having 10 μm by a doctor blade method and was then temporarily dried. The anode thus obtained had a thickness of about 30 μm. Before assembly of a cell, the anode was dried in a roll type under the vacuum state at a temperature of 120° C. for 10 hours.

### 2) Manufacturing of Cathode

Activated carbon, which is obtained by an alkali activation method and has a specific surface area of about 2200 m²/g, was used. Activated carbon powder, acetylene black, and binders (PTFE/CMC/SBR) were mixed at a weight ratio of 80:10:10, respectively. Then, the mixture was added to water, followed by agitation and mixing, thereby obtaining slurry. This slurry was coated on a copper foil having 20 μm by a doctor blade method and was then temporarily dried. The cathode thus obtained had a thickness of about 60 μm. Before assembly of a cell, the cathode was dried in a roll type under the vacuum state at a temperature of 120° C. for 20 hours.

### 3) Production of Electrolyte Solution

Lithium hexafluorophosphate (LiPF₆) was solved in an organic solvent in which EC, PC, and DEC were mixed at a weight ratio of 3:1:2 such that it had a concentration of 1.2 mol/L, thereby obtaining an electrolyte solution.

### 4) Pre-Doping Anode With Lithium Ion And Manufacturing of Lithium Ion Capacitor

A separator was positioned between a lithium metal film and an anode and charging was performed between the lithium metal film and the anode (1 A, for 10 hours) to thereby allow lithium ions to be absorbed and stored in the anode. A content of the lithium pre-doped was regulated such that it becomes about 85% based on total anode capacity.

Then, the anode pre-doped with lithium ions was dried. The dried pre-doped anodes thus obtained and cathodes were stacked, having the separator therebetween, thereby manufacturing a lithium ion capacitor.

### 5) Assembly of Lithium Ion Capacitor Cell

The separator enclosed the stacked lithium ion capacitor to thereby form an electrode unit. Then, the electrode unit was put into a laminate film and an electrolyte solution was injected thereinto in a vacuum state. Through the above-mentioned process, a lithium ion capacitor cell having a capacitance of 1000 F was obtained.

### Experimental Example: High Temperature Cycle Evaluation of Lithium Ion Capacitor Cell

The lithium ion capacitor cell was charged up to 3.8V at a constant current-constant voltage and was then discharged up to 2.0 V at a constant current in a thermoset having a temperature of 60° C. for 900 seconds. After 10 seconds, charging and discharging operations were repeated under the same condition. After 1000 cycles, measurement was stopped.

Then, the lithium ion capacitor cell was maintained in the thermoset having a temperature reduced to 25° C. for 10 hours. Next, the lithium ion capacitor cell was charged up to 3.8 V at a constant current-constant voltage for 900 seconds and was then discharged up to 2.0 V at a constant current. After 1000 cycles, a capacitance was measured.

After 1000 cycles, the capacitance was maintained in the ratio of 98% with respect to an initial capacitance of a corresponding cell at a temperature of 25° C. The initial capacitance was 1008. This result confirmed that the lithium ion capacitor including an anode manufactured by pre-doping lithium ions thereon according to the present invention had excellent effect in capacitance retention.

Furthermore, the present invention can provide a high-capacitance capacitor capable of operating even at a high voltage range of up to 3.8V to 2.0V, and ensure high reliability even in a high-temperature (60° C.) cycle.

As set forth above, according to the pre-doping method of lithium ion of the present invention can directly pre-dope lithium ions on the anode from the lithium metal film, thereby simplifying the manufacturing process, and can perform pre-doping with better reproducibility.

Furthermore, according to the method of the present invention, pre-doping can be performed in variously methods, by, for example, performing pre-doping on a separate anode through a charging method, manufacturing a lithium ion capacitor through lamination of these anodes and cathodes, and positioning laminated lithium metal films with respect to respective anodes having a lamination structure and performing charging.

Therefore, the lithium ion capacitor storage device including the anode manufactured by the method of the present invention can provide a high-capacitance capacitor capable of operating even at a high voltage range of up to 3.8V to 2.0V, and ensure high reliability even in a high-temperature (60° C.) cycle.

The present invention has been described in connection with what is presently considered to be practical exemplary embodiments. Although the exemplary embodiments of the present invention have been described, the present invention may be also used in various other combinations, modifications and environments. In other words, the present invention may be changed or modified within the range of concept of the invention disclosed in the specification, the range equivalent to the disclosure and/or the range of the technology or knowledge in the field to which the present invention pertains. The exemplary embodiments described above have been provided to explain the best state in carrying out the present invention. Therefore, they may be carried out in other states known to the field to which the present invention pertains in using other inventions such as the present invention and also be modified in various forms required in specific application fields and usages of the invention. Therefore, it is to be understood that the invention is not limited to the disclosed embodiments. It is to be understood that other embodiments are also included within the spirit and scope of the appended claims.

What is claimed is:

1. A method for pre-doping an anode, comprising:
disposing lithium metal films and anodes alternately; and
charging the lithium metal films and the anodes to directly pre-dope lithium metal contained in the lithium metal films onto the anodes.

2. The method according to claim 1, wherein a separator is disposed between the lithium metal film and the anode.

3. The method according to claim 1, wherein the lithium metal film is fixed to a current collector of at least one selected from a group consisting of nickel, copper, aluminum, and an alloy thereof.

4. The method according to claim 1, wherein a separate electrolytic solution is unnecessary at the time of pre-doping.

5. The method according to claim 1, wherein a content of lithium pre-doped is 80 to 95% of anode capacity.

6. The method according to claim 1, wherein the charging is performed under the condition of 0.005 to 2 A for 10 to 24 hours.

7. The method according to claim 1, wherein discharging after charging is not performed at the time of pre-doping.

8. A lithium ion capacitor comprising the anode manufactured by the pre-doping method according to claim 1.

9. The lithium ion capacitor according to claim 8, wherein an active material for the anode is selected from carbon materials having an interplanar spacing of [002] surface of 0.335 to 0.410 nm, which is measured by an X-ray diffraction method.

10. A method for manufacturing a lithium ion capacitor, comprising:
stacking cathodes and anodes, which are insulated from each other by separators; and
charging the stacked anodes by using lithium metal films to pre-dope lithium ions of the lithium metal films onto the anodes.

11. The method according to claim 10, wherein the lithium metal films have a stacked structure in order to charge the respective anodes stacked.

12. The method according to claim 10, wherein the lithium ion metal film contains lithium ions, of which a content is such that the lithium ions are pre-doped onto the anode.

13. The method according to claim 12, wherein a content of lithium ions pre-doped onto the anode is 80 to 95% of anode capacity.

14. The method according to claim 10, wherein the lithium metal film is fixed to a current collector of at least one selected from a group consisting of nickel, copper, aluminum, and an alloy thereof.

15. The method according to claim 10, wherein the charging is performed under the condition of 0.005 to 2 A for 10 to 24 hours.

16. The method according to claim 10, wherein an active material for the anode is selected from carbon materials having an interplanar spacing of [002] surface of 0.335 to 0.410 nm, which is measured by an X-ray diffraction method.
